(19) United States
(12) Patent Application Publication
(10) Pub. No.: US 2002/0087438 A1
(43) Pub. Date: Jul. 4, 2002

(54) Order assembly production system and method

(76) Inventors: Yukio Kunieda, Akiruno-shi (JP); Yuuji Takamatsu, Urawa-shi (JP); Tsuyoshi Kiyota, Ome-shi (JP); Hitoshi Tokuda, Ome-shi (JP); Shizuo Ishikawa, Nishitama-gun (JP)

Correspondence Address: FOLEY & LARDNER, 2029 CENTURY PARK EAST, SUITE 3500, LOS ANGELES, CA, 90067

(21) Appl. No.: 10/028,996

(22) Filed: Dec. 21, 2001

(30) Foreign Application Priority Data
Dec. 28, 2000 (JP) 2000-400823

(51) Int. Cl. G06F 17/60

(52) U.S. Cl. 705/28

(57) ABSTRACT

An order assembly production system and method comprises a vender managed inventory (VMI) system and a forecast presented to a component vender. A prospect production is performed until intermediate products are obtained, the intermediate products are stocked, and final assembly is performed after an order is accepted. The final assembly is performed from the intermediate product, resulting in a shorter lead time and preventing the loss of sales opportunities due to shortages. Since no final product is stocked, excess production is avoided. In addition, because the intermediate products may be designed to be general-purpose and may be used in a plurality of products, demand fluctuations for the intermediate products can be buffered.

### CROSS-REFERENCE TO RELATED APPLICATIONS

This application is based upon and claims the benefit of priority from the prior Japanese Patent Application No. 2000-400823, filed Dec. 28, 2000, the entire contents of which are incorporated herein by reference.

### BACKGROUND OF THE INVENTION

1. Field of the Invention

The present invention relates in general to a production system and method for product assembly, and more particularly to a production system and method having a short lead time which does not cause excess production or lost sales opportunities.

2. Description of the Related Art

In general, the production flow from a number of discrete product components to a finished product incorporating those components generally comprises the following steps: (1) component design; (2) product design; (3) component procurement; (4) component stocking in a manufacturer's component warehouse; (5) component processing in a manufacturing facility (“factory”); (6) product stocking in the manufacturing facility; (7) final product assembly in the manufacturing facility; (8) final product stocking in a product warehouse; (9) shipment of final products; (10) final product stocking in an intermediate warehouse; and (11) delivery/installation of the final product.

Conventional production systems can be roughly classified into the following two systems.

An engineering-to-order (or made-to-order production system), wherein one or both of steps 1 and 2 discussed above (i.e., component design and/or product design) are initiated after an order is received, is generically called an “individual order production system.”

On the other hand, a made-to-stock production system (or sale-to-stock production system), wherein one or both of steps 7 and 9 discussed above (i.e., final product assembly and/or factory shipment) are performed before receiving the order, is generically called a “prospect production system.” In the prospect production system, the final products are held or stored (“stocked”) in a product warehouse or shipped to and stocked in an intermediate warehouse (steps 8 and 10) until an order for the final product is received.

There are benefits and drawbacks to both the individual order production system and the prospect production system. Because there is at present a rapid pace of technical innovation, the value of the product or component may quickly fall. Additionally, due to market competition, product pricing competition may be very keen. Moreover, in order to meet the needs and desires of today's demanding consumers for new and improved product features, a product's components and specifications will constantly be changing.

Under these circumstances, one benefit of the order production system is that because production of products is not performed based on a forecast, but only based on actual orders for the product, excess production leading to increased inventories of unordered products is avoided. However, one drawback of the individual order production system is that there is a longer lead time before shipment of the product after the product is ordered. Thus, in such systems, loss of sales opportunities may result because the product is not readily available.

In contrast, one benefit of the prospect production system is that the lead time from order placement to shipment of the product is shortened because the products are already assembled and stocked. However, one drawback of the prospect production system is that the quantity of products assembled and stocked is based on a demand forecast of a considerably future time (usually, one or more months ahead), and, thus, the accuracy of the demand forecast may be questionable. If the forecast proves wrong (e.g., the demand is less than the forecast demand), the product inventory may increase because of excess production. This increase in product inventory may lead to outdated product stock, collapse of the product price, lower evaluation of a component of the product, deterioration of cash flow, increased depreciation expenses, and the like. Moreover, when demand is larger than the forecast, a shortage occurs, and there may be lost sales opportunities.

Thus, it can be seen from the foregoing that to minimize the possibility of excess production (and thus the possibility of having an outdated product inventory) due to the actual demand for a product being lower than the demand forecast, the lead time is necessarily lengthened. Moreover, it can also be seen from the foregoing that to minimize the loss of sales opportunities, various products have to be supplied in a short lead time. In the two conventional production systems described above, minimization of both excess production and lead time from order placement to shipment of the product cannot simultaneously be achieved.

Additionally, as an example of the conventional individual order production system, “Manufacturing System and Assembly System of Computer System in Order Manufacturing Environment” is described in Japanese Patent Publication (KOKAI) No. 11-285936 (published on Oct. 19, 1988). In this prior-art example, a kit tray is prepared in response to a received order, and the constituent components for respective ordered products are held in the kit tray. The kit tray is transferred to an operation cell, and a team assembles the product in the cell. Thereafter, the product is tested and repaired based on information about an arbitrary problem given to the managing operation cell.

For the conventional production systems described, the lead time is lengthened in the individual order production system. On the other hand, in the prospect production system the demand forecast may be proved wrong, leading disadvantageously to either excess production or the loss of sales opportunities.

### BRIEF SUMMARY OF THE INVENTION

Embodiments of the invention pertain to an assembly production system and method which enables products to be delivered to a manufacturer within a short lead time.

Additional embodiments of the invention pertain to an assembly production system and method which minimizes excess production of final products or lost opportunities due to shortages of the final products.

Preferred embodiments of the invention address the foregoing shortcomings of conventional production systems by providing an order assembly production system comprising first preparation means for preparing forecast data indicating a quantity and a time by which a component vender is to provide vender managed inventories based on a production plan. First presentation means may present the forecast data generated by the first preparation means to the component vender a predetermined period before a presentation of a stock instruction. Second preparation means may modify the forecast data in consideration of a fluctuation factor, and may prepare the stock instruction. Second presentation means may present the stock instruction generated by the second preparation means to the component vender a predetermined period before a presentation of a discharge instruction. Means are provided for storing the vender managed inventories based on the stock instruction presented by the second presentation means. Third presentation means may present the discharge instruction to the component vender to discharge the vender managed inventories stored by the storing means in accordance with an order.

Further preferred embodiments provide an order assembly production system comprising means for calculating demand forecast data based on sales prospect data. The system also provides means for calculating material required amount plan data based on a received order and the demand forecast data. In addition, the system provides means for issuing an order to a component vender based on the material required amount plan data, and warehousing components in a component warehouse. Furthermore, the system provides manufacturing instruction means for processing the components in the component warehouse based on the material required amount plan data, and manufacturing intermediate products. The system also provides means for storing the intermediate products manufactured by the manufacturing instruction means. The system further provides means for processing the intermediate products in the storing means based on the received order and starting manufacturing of a final product.

Yet other preferred embodiments provide an order assembly production method comprising depositing at least one of intermediate products processed from a component of a component vender and intermediate products of the component vender in a warehouse of a manufacturer while ownership remains in the component vender. The deposited intermediate products may be discharged from the warehouse in response to a received order. Final assembly may be performed by the manufacturer using the discharged intermediate products. The component vender may be paid for the discharged intermediate products.

In addition, further preferred embodiments provide an order assembly production method comprising forecasting a manufacturing plan for at least one of a component delivery company and intermediate product delivery company. A delivery quantity of at least one of components and intermediate products may be indicated to at least one of the component delivery company and intermediate product delivery company based on the manufacturing plan, a component constitution of a product, and a stock situation. At least one of the indicated components and intermediate products may be deposited in a warehouse. The deposited components and/or intermediate products may be released out of the warehouse in response to a received order. Final products may be assembled using at least one of the released components and intermediate products.

These and other features and advantages of embodiments of the invention will be apparent to those skilled in the art from the following detailed description of embodiments of the invention, when read with the drawings and appended claims.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIGS. 1A and 1B are a diagram showing an order assembly production system according to a first embodiment of the present invention in comparison with an individual order production system and prospect production system, and FIG. 1C shows the manner in which FIGS. 1A and 1B are combined;

FIGS. 2A and 2B are diagrams showing a comparison between a forecast/prospect handling business and a received order handling business in the prospect production system and order assembly production system;

FIGS. 3A and 3B are a block diagram showing an outline of the order assembly production system according to the first embodiment, and FIG. 3C shows the manner in which FIGS. 3A and 3B are combined;

FIG. 4 is a flowchart showing an outline of an operation of the order assembly production system shown in FIGS. 3A and 3B;

FIG. 5 is a diagram showing an outline of a vender managed inventory (VMI) system for use in the order assembly production system according to the first embodiment;

FIGS. 6A and 6B are a diagram showing a detailed view of the vender managed inventory system, and FIG. 6C shows the manner in which FIGS. 6A and 6B are combined;

FIG. 7 is a diagram showing forecast information to be presented to a contractor (component vender);

FIG. 8 is a diagram showing an outline of the whole order assembly production system according to the first embodiment;

FIGS. 9A, 9B, 9C, 9D, 9E, and 9F are a diagram showing a detailed view of the whole order assembly production system according to the first embodiment, and FIG. 9G shows the manner in which FIGS. 9A, 9B, 9C, 9D, 9E, and 9F are combined; and

FIG. 10 is a flowchart showing an operation of FIGS. 9A, 9B, 9C, 9D, 9E, and 9F.

### DETAILED DESCRIPTION OF THE INVENTION

An embodiment of an order assembly production system according to the present invention will be described hereinafter with reference to the drawings. Manufacturing of a personal computer will be described as an example.

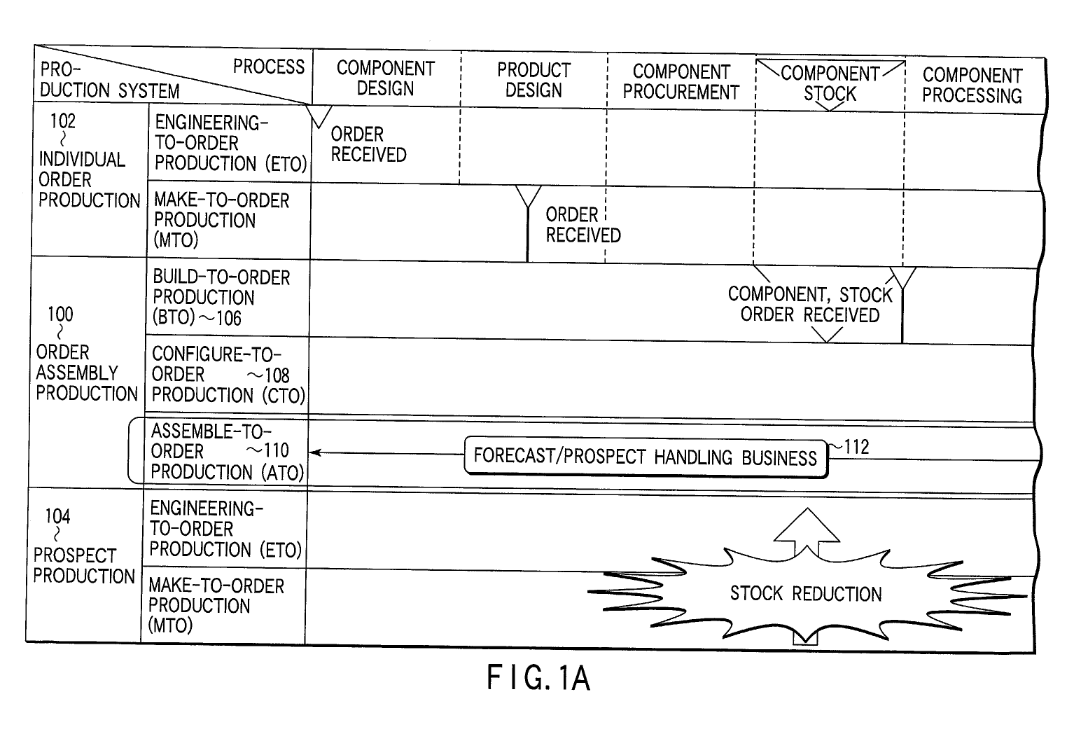

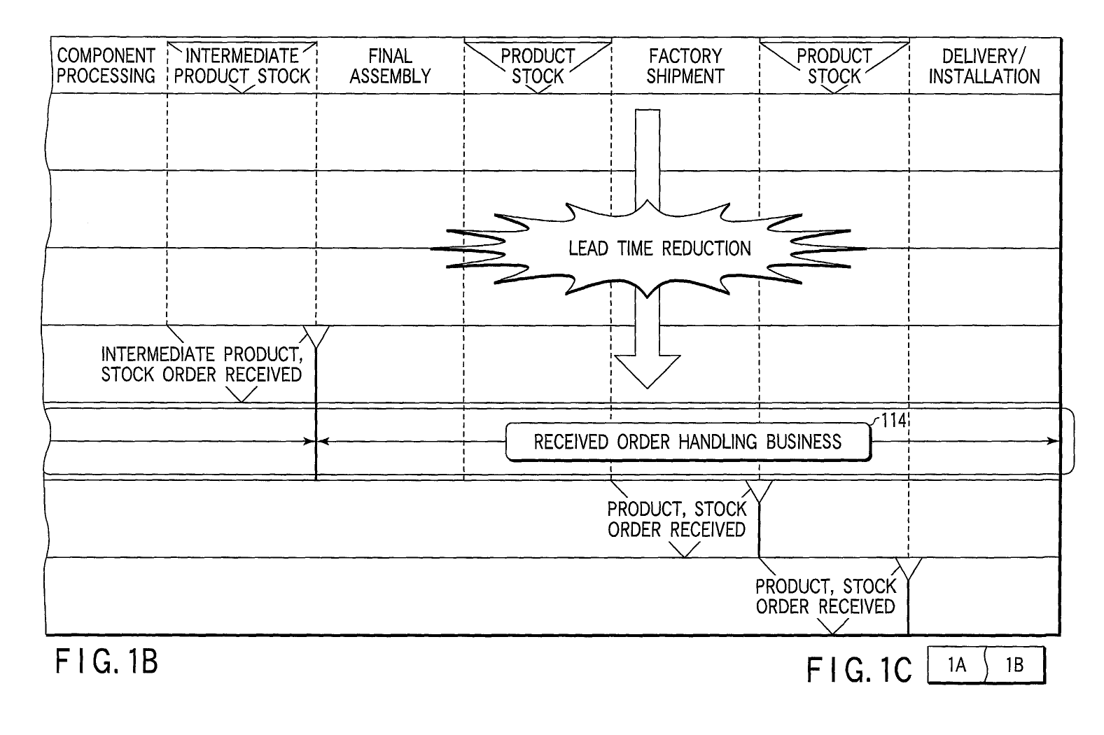

FIGS. 1A and 1B, arranged according to FIG. 1C, show a comparison of an embodiment of the order assembly production system 100 to an individual order production system 102 and a prospect production system 104. The order assembly production system 100, broadly viewed, includes a build-to-order (BTO) system 106 (a component is stocked and component processing is started in response to the received order), a configure-to-order (CTO) system 108 (the intermediate product is stocked and final assembly of a specification is started in response to the received order), and an assemble-to-order (ATO) production system 110 (the intermediate product is stocked and final assembly is started in response to the received order). The present embodiment relates specifically to the assemble-to-order production system 110.

According to the embodiment, to establish both lead time reduction and product stock reduction, a product is constituted as a module (intermediate product), the intermediate product is produced in a planned manner based on a prospect, and is stocked. Examples of the intermediate product include an LCD panel, battery, HDD (hard disk drive), FDD (floppy disk drive), GA (gate array), memory, keyboard, AC adapter, VGA (video graphic array), and a printed board with these products mounted thereon. In the assemble to order production system 110 of the present embodiment, the steps taken prior to when the intermediate product is stocked correspond to a forecast/prospect handling business 112. The steps taken after the intermediate product is finally assembled correspond to a received order handling business 114.

As described above, intermediate products are stocked rather than components. Therefore, when compared to the individual order production system described above, lead time from receipt of an order to shipment of the product can be greatly reduced. In addition, in contrast to the prospect production system described above, a final product is not stocked, and therefore deterioration of cash flow and increased depreciation expenses can be prevented. Furthermore, if the intermediate product is usable in a plurality of products, a fluctuation in the demand for a certain final product can be buffered, and increased inventories or shortages of the intermediate product can be prevented by using the intermediate product as a constituent part of another product that may currently be in high demand.

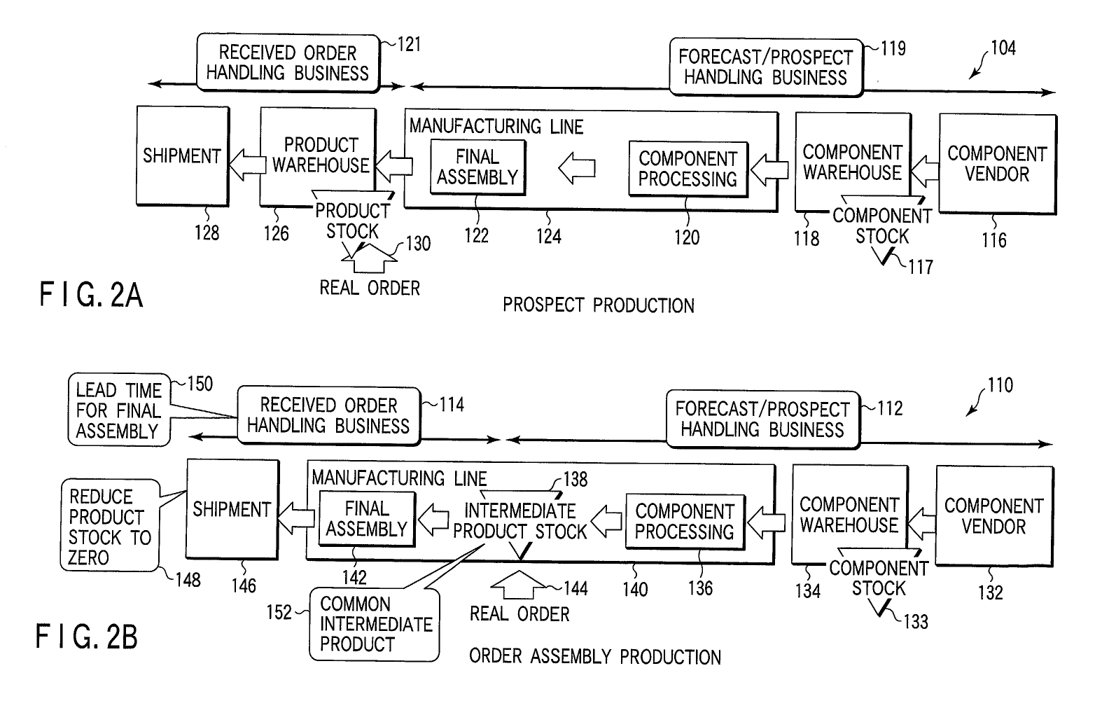

FIGS. 2A and 2B are diagrams showing a prospect production system 104 and the assembly-to-order production system 110 of the present embodiment in a more detailed comparison.

As shown in FIG. 2A, in the prospect production system 104, components delivered from a component vender 116 are stocked as component stock 117 in a manufacturer's component warehouse 118. The components discharged from the component warehouse are subjected to component processing 120 and supplied to final assembly 122 of a manufacturing line 124. The entire process shown in FIG. 2A, from delivery from a component vender 116 to final assembly 122 is a forecast/prospect handling business 119 process. The forecast/prospect handling business 119 is based on a monthly forecast. It is difficult to operate the manufacturing line based on a forecast/prospect that is provided on a more frequent basis. After final assembly 122, a final product (finished product) is stocked in a product warehouse 126. The product is shipped 128 from the product warehouse 126 in response to actual order (real order 130) data. The received order handling business 121 is performed from the time the real order 130 is received until shipment 128 of the final product. The real order 130 can be generated on a daily basis.

In the assembly-to-order production system 110 of the present embodiment shown in FIG. 2B, components delivered from a component vender 132 are stocked as component stock 133 in a component warehouse 134. The components discharged from the component warehouse 134 are subjected to component processing 136. However, in contrast to the prospect production system 104 shown in FIG. 2A, after component processing 136, the resulting intermediate products are not immediately supplied to the final assembly 142, but are stocked in an intermediate product warehouse (not shown) as intermediate product stock 138. At that point, the forecast/prospect handling business 110 process is completed.

A manufacturing line 140 for producing the intermediate product has more flexibility than a manufacturing line for producing the final assembly 142, and a prospective cycle for manufacturing the intermediate product can be reduced to about one week.

Upon receiving the actual order (real order 144), the intermediate products are discharged from the intermediate product warehouse, and supplied to the final assembly 142 of the manufacturing line 140. The products subjected to the final assembly 142 are directly shipped 146. The process from the receipt of the real order 144 until the shipment 146 of the final product is the received order handling business 114 process.

In the present system, when the final assembly 142 is started from the intermediate product based on the received real order 144, the product stock can be zero, as indicated by reference numeral 148. Additionally, since the final assembly is performed from the intermediate products, the lead time 150 from the receiving of the real order 144 to the shipment 146 can be short. Furthermore, since the intermediate products are used in common with respect to a large number of products, (i.e., they are general purpose), as indicated by reference numeral 152, they may be diverted to other products. Thus, fluctuations in demand can be handled, and the intermediate product stock 138 may be reduced. Moreover, since the final assembly 142 is performed based on the received real order 144, a customer's preferences (e.g., MHz value of a CPU clock, memory capacity, or the capacity of a hard drive) may be specified at the time the order is placed.

As shown in FIG. 2A, in the prospect production system 104, the final assembly 122 is performed based on a prospect, and the final products are stocked as the product stock 130. However, it is difficult to stock a great variety of products as the final products. When the forecast proves wrong, and actual demand is more than the forecast, a long lead time from the processing of the components to the shipment of the final product is necessary. A shortage of components may further increase the lead time.

As shown in FIG. 2B, the assembly-to-order production system 110 of the present embodiment includes the following advantages over the prospect production system 104 shown in FIG. 2A: (1) an intermediate stock point 138 in the manufacturing line, (2) final assembly 142 in response to the real order 144, (3) flexibility in adapting to a demand forecast error, and (4) prevention of excess production and loss of sales opportunities.

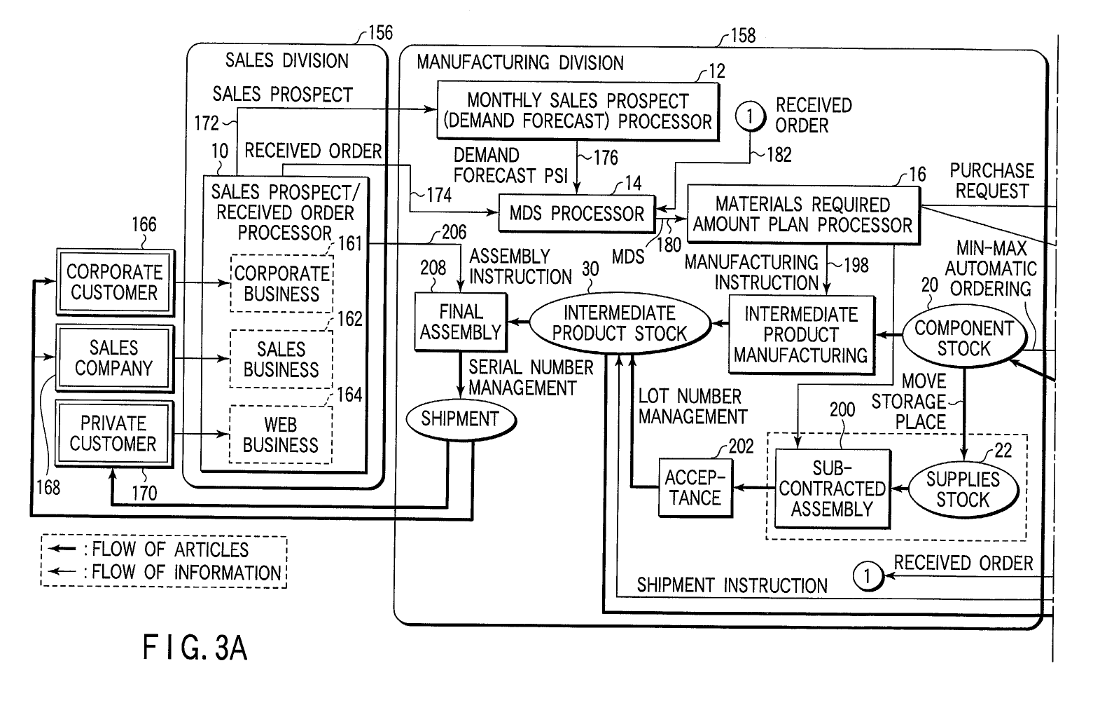

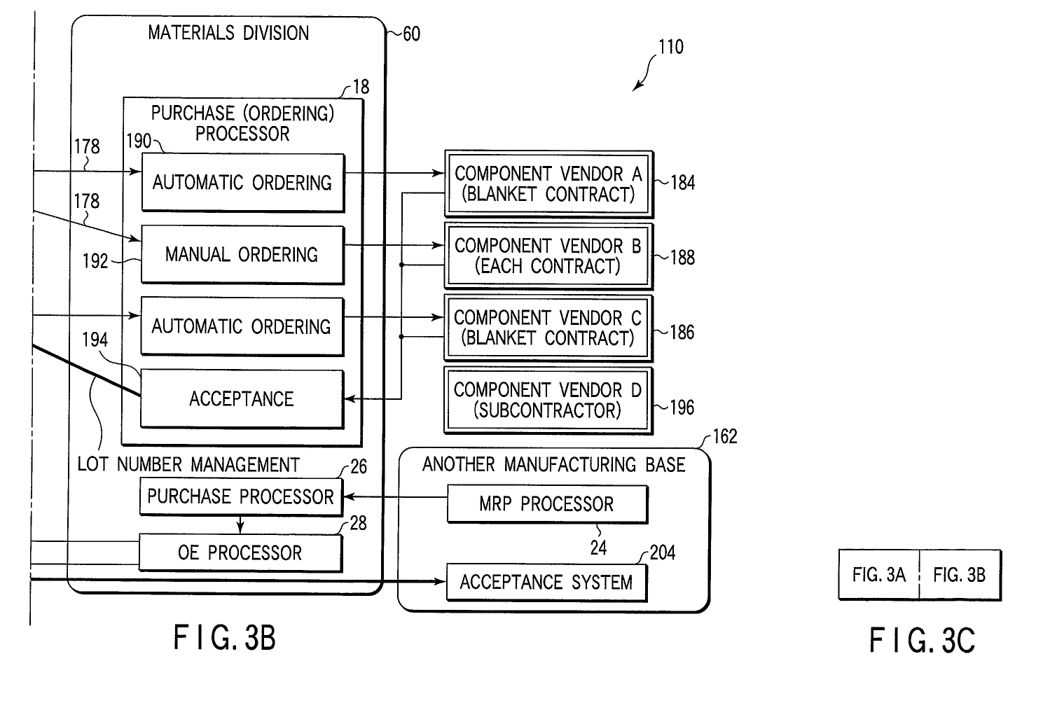

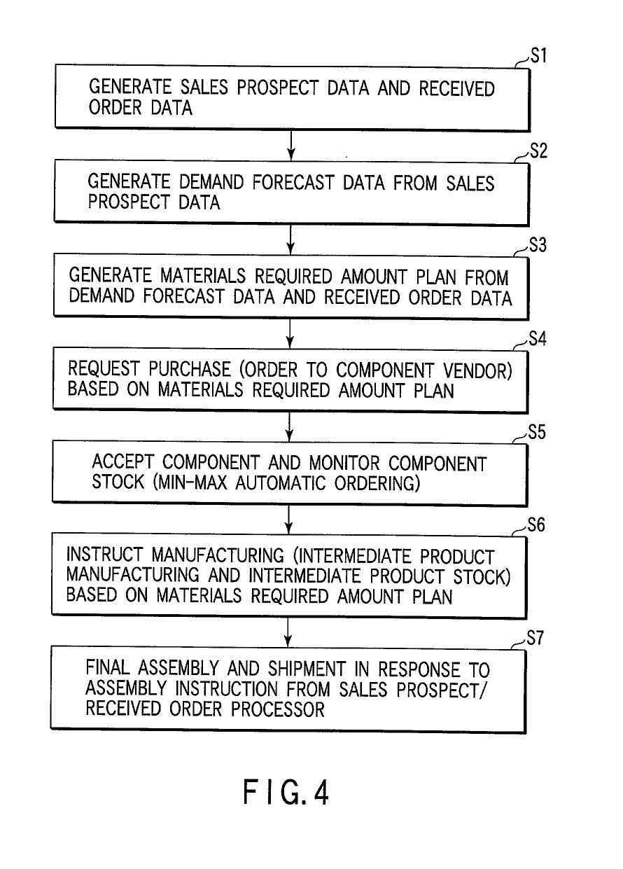

FIGS. 3A and 3B, arranged according to FIG. 3C, are a block diagram showing an embodiment of the assembly-to-order production system 110, and FIG. 4 is a flowchart showing an operation of the system. The present system comprises sub systems such as a sales division 156, a manufacturing division 158, a materials division 160, and another manufacturing base 162. Examples of another manufacturing base 162 include a manufacturing department of the same company located in a place other than the manufacturing division 158.

The sales division 156 has a sales prospect/received order processor 10, receives corporate business data 161, sales business data 162, and Web business data 164 from a corporate customer 166, a sales company 168, and private customer 170, respectively, and obtains sales prospect data 172 and received order data 174 (step S1).

The manufacturing division 158 includes a monthly sales prospect (demand forecast) processor 12, an MDS (master demand schedule) processor 14, and a material required amount plan processor 16. The monthly sales prospect processor 12 obtains a monthly sales prospect (demand forecast PSI (products-sales-inventory) for demand adjustment of the products and components) from a sales prospect 172 (step S2). The MDS processor 14 obtains a master demand schedule (MDS) (so-called production plan) from demand forecast data 176 and received order data 174 (step S3). The material required amount plan processor 16 obtains purchase request data 178 from MDS data 180 and received order data 182 from the materials division 160.

The material required amount plan processor 16 transfers the purchase request data 178 to a purchasing (ordering) processor 18 of the materials division 160, and sends the order to a component vender A 184 or C 186 (blanket contract), or a component vender B 188 (each contract) by an automatic ordering system 190 or a manual ordering system 192 (step S4). After the components delivered from the component vender (184, 186, 188) are accepted by an acceptance system 194, the components are stored as the component stock in a component warehouse 20 of the manufacturing division 158. The component warehouse 20 also manages a lot number.

The components in the component warehouse 20 are also moved to a warehouse 22 of a component vender D 196 (subcontractor), and stored as a supplies stock. The warehouse 22 of the component vender D 196 is physically in a company of the component vender D 196, and is outside the manufacturing division 158 of the company, but is regarded as being in the manufacturing division 158 for the sake of management of the system. On the other hand, the component warehouse 20 constantly monitors a warehousing amount and discharge amount, and updates a stock amount. When the stock amount is less than a defined amount, an order is automatically sent to the component vender 184, 188)(blanket contract) via the automatic ordering system 190 of the materials division 160 in order to obtain the defined amount (Min-Max automatic ordering: step S5).

Material requirements planning (MRP) data from an MRP processor 24 (a system for arranging a master production plan by component development of a product constitution, and optimizing/managing a flow of articles for forming the finished product from material on a time base) in another manufacturing base 162 is supplied to an order entry (OE) processor 28 via a purchase processor 26 of the materials division 160. The OE processor 28 supplies received order data 182 to the MDS processor 14.

The components in the component warehouse 20 are discharged from the warehouse based on manufacturing instruction data 198 from the material required amount plan processor 16, and the intermediate products are manufactured, transferred to an intermediate product warehouse 30, and result in the intermediate product stock (step S6)

The components in the supplies warehouse 22 are also discharged from the warehouse based on the manufacturing instruction data 198 from the material required amount plan processor 16, subcontracted assembly 200 by the component vender D 196 is performed, and the intermediate products are manufactured. The intermediate products obtained by the subcontracted assembly 200 are delivered into the intermediate product warehouse 30 via an acceptance system 202. The intermediate product warehouse 30 also manages the lot number. Moreover, the intermediate products in the intermediate product warehouse 30 are also sent to an acceptance system 204 of another manufacturing base 162.

The components in the intermediate product warehouse 30 are discharged from the warehouse 30 based on assembly instruction data 206 from the sales prospect/received order processor 10, and the final assembly 208 is performed (step S7). Serial numbers of the finished products are managed, and the finished products are shipped to the private customer 170, corporate customer 166, and sales company 168.

According to the assembly-to-order production system 110, the components are purchased based on the demand forecast 176, and the intermediate products are manufactured, and held as the stock, so that the finished products can directly be shipped in response to an assembly instruction 206 based on the order 174 received from the sales division 156. Further, the ordering of the components and the manufacturing of the intermediate products from the components, are based on the demand forecast 176, and there is little fear of an increase of the stock inventory of the intermediate products. Moreover, even if the stock inventory of the intermediate products increases due to fluctuation of demand for the product, the intermediate products are designed to be general purpose, and can be diverted to other products. Therefore, the negative effects of demand fluctuation are minimized.

In the assembly-to-order production system 110, a certain amount of intermediate product stock must always be available, and a degree of stability in the procurement of components is important. A vender managed inventory system for procurement of components will next be described.

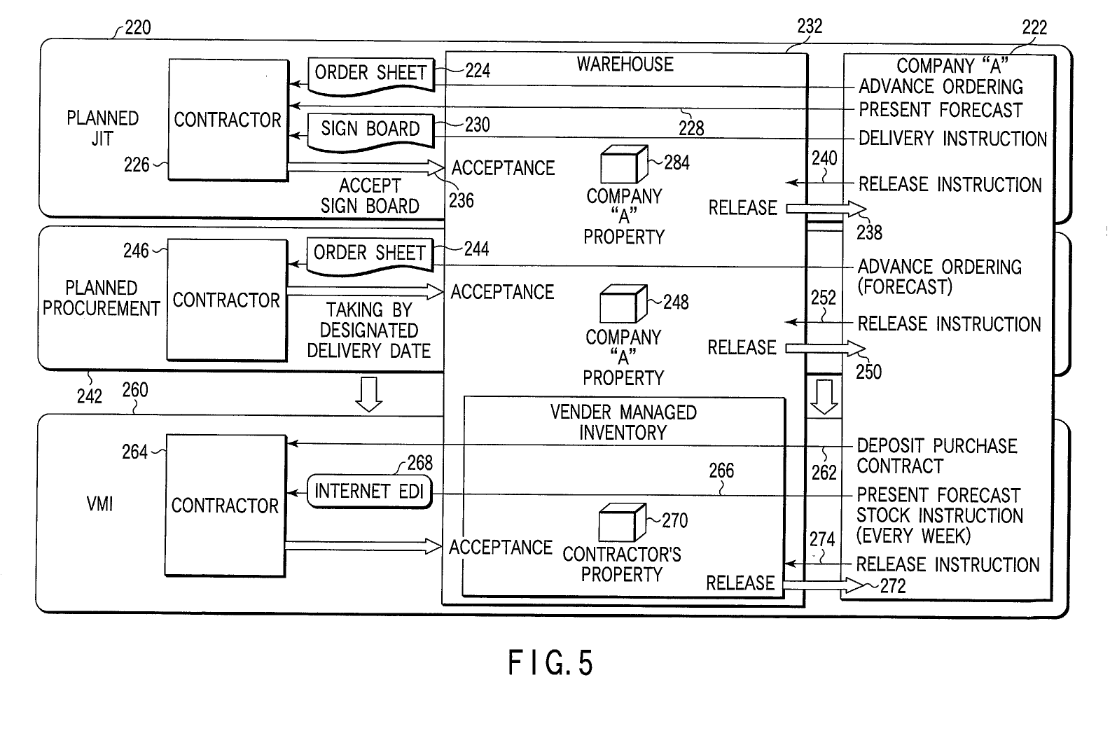

FIG. 5 shows, for comparison, a planned just-in-time (JIT) system 220 (the components are delivered while a component delivery date is adapted for a necessary time in accordance with a production process), a planned procurement system 242, and vender managed inventory (VMI) system 260. Here, the components include not only simple components but also intermediate products subjected to manufacturing.

In the planned JIT system 220, company “A” 222 (manufacturer) as an orderer issues an order sheet 224 to a contractor 226 (component vender 226) in advance, and a future manufacturing plan is forecast 228. The contractor 226 starts component delivery preparation (manufacturing) according to the forecast 228. When the components are required, the company “A” 222 sends a delivery instruction 230 to the component vender 226. The component vender 226 delivers the components into the component warehouse 232. The company “A” 222 brings the components into a company's property 234 when the components are accepted 236 (just in time). Thereafter, the components are released 238 from the component warehouse 232 in accordance with a release instruction 240.

In the planned procurement system 242, the company “A” 222 sends the order sheet 244 to the contractor 246 (component vender 246) in advance, and forecasts a future manufacturing plan. In the planned JIT system 220, the components are delivered in response to the delivery instruction 230. However, in the planned procurement system 242, a delivery date is designated at the time of the advance ordering, and the component vender 246 delivers the components into the warehouse 232 by the delivery date designated in the order sheet 244. Also in this case, the company “A” 222 brings the components into the company's property 248 when the components are received. Thereafter, the components are released 250 to the company “A” 222 from the warehouse 232 in accordance with the release instruction 252.

In contrast, in the vender managed inventory (VMI) system 260 (the components remaining in a contractor's ownership are deposited/stocked in the factory warehouse, and payment is made for the components discharged from the factory and used in production), first the company “A” 222 concludes a deposit purchase contract 262 with the contractor 264. Subsequently, the company “A” 222 forecasts a future manufacturing plan to the contractor 264, and presents to the contractor 264, every week, a stock instruction 266 (the required number of components) for the following week. The forecast and stock instruction 266 are presented via an Internet electronic data interchange (EDI) system 268 (a system in which transaction data (SLIP format) between the companies is interchanged according to a domestic or standard format). As described above, since the contractor 264 is also informed of a stock situation, the contractor 264 starts the manufacturing of the components based on the forecast, and delivers a designated quantity of components into the component warehouse 232 by a date designated in the stock instruction 266.

Additionally, when the components are delivered into the warehouse 232, the ownership is not transferred, and the components still remain the contractor's property 270. Thereafter, the components discharged from the component warehouse 232 are used in the component assembly, the intermediate products are manufactured, and the intermediate product stock results. The intermediate product stock is also left in the contractor's property 270 without transferring the ownership. Thereafter, the intermediate products are released 272 to the company “A” 222 in response to the release instruction 274, and the ownership of the intermediate products shifts to the company “A” 222 for the first time at the release 272 (the payment is made to the vender).

Both the orderer (for example, company “A” 222) and the component vender (for example, contractor 264) obtain advantages from the VMI system 260 described in relation to FIG. 5. For example, one advantage to the orderer from the VMI system 260 is that the components and intermediate product stock in the warehouse are the contractor's property, and the amount of stock inventory owned by the orderer is consequently reduced. Another advantage to the orderer is that the required amount of stock is more easily obtained (i.e., improved stability of stock procurement).

One advantage for the component vender from the VMI system 260 is that the production plan is stabilized by the forecast (once per month in the conventional system, but once per week in the VMI system 260). As a further advantage to the component vender from the VMI system 260 compared to the planned JIT system 220, stock transportation timing is easily controlled, and the stock situation can be updated.

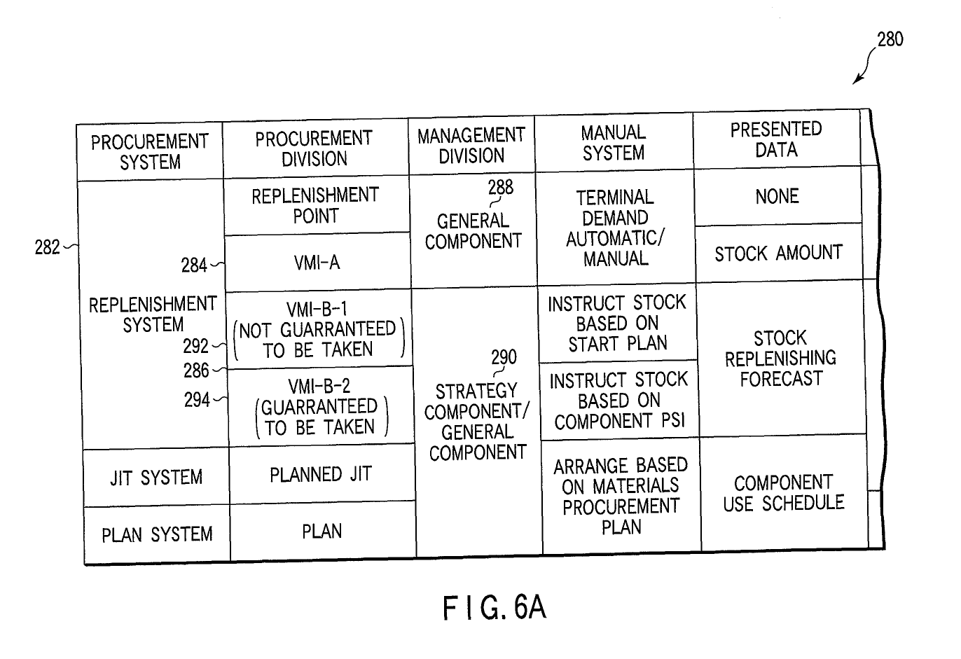

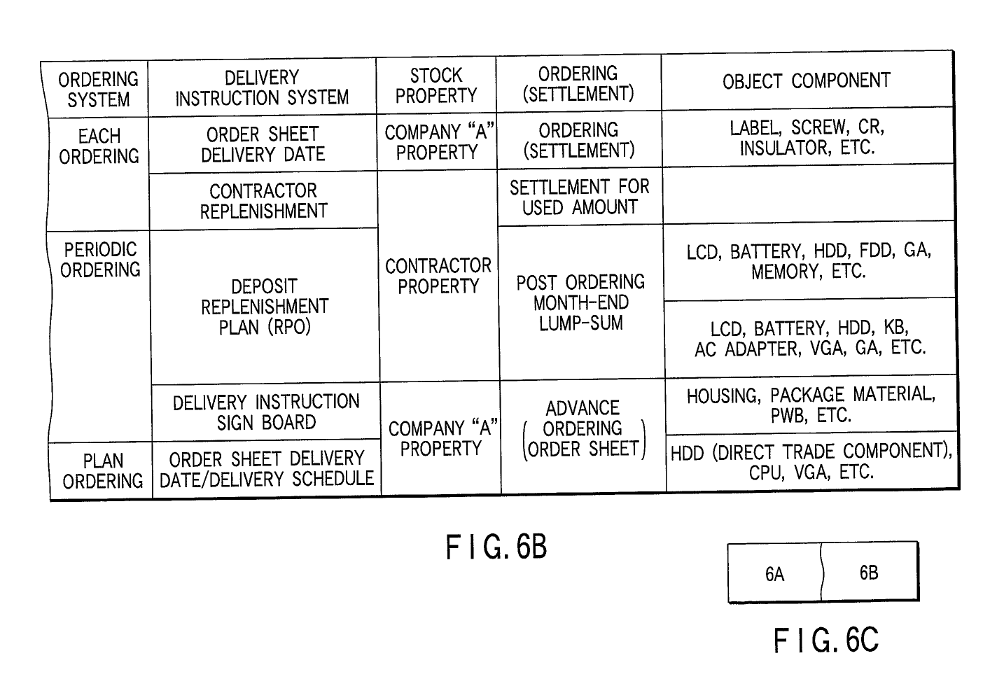

FIGS. 6A and 6B, arranged according to FIG. 6C, show a comparison of the various above-described component procurement systems. The components are not limited to pure components, and also include the intermediate products produced by subjecting the components to component processing. The VMI system is regarded as a replenishment system 282. The VMI system is also further divided into two VMI subsystems, that is, a VMI subsystem (VMI-A 284) for a general component 288 and a VMI subsystem (VMI-B 286) for a strategy component/general component 290. The VMI subsystem 286 for the strategy component/general component 290 is further divided into VMI-B-1 not guaranteed to be taken subsystem 292 (market general-purpose components divertible to other company products, such as LCD, battery, HDD, FDD, gate array, and memory), and VMI-B-2 guaranteed to be taken subsystem 294 (not market general-purpose components, but components divertible to the company's other products, such as LCD, battery, HDD, keyboard, AC adapter, VGA, and gate array).

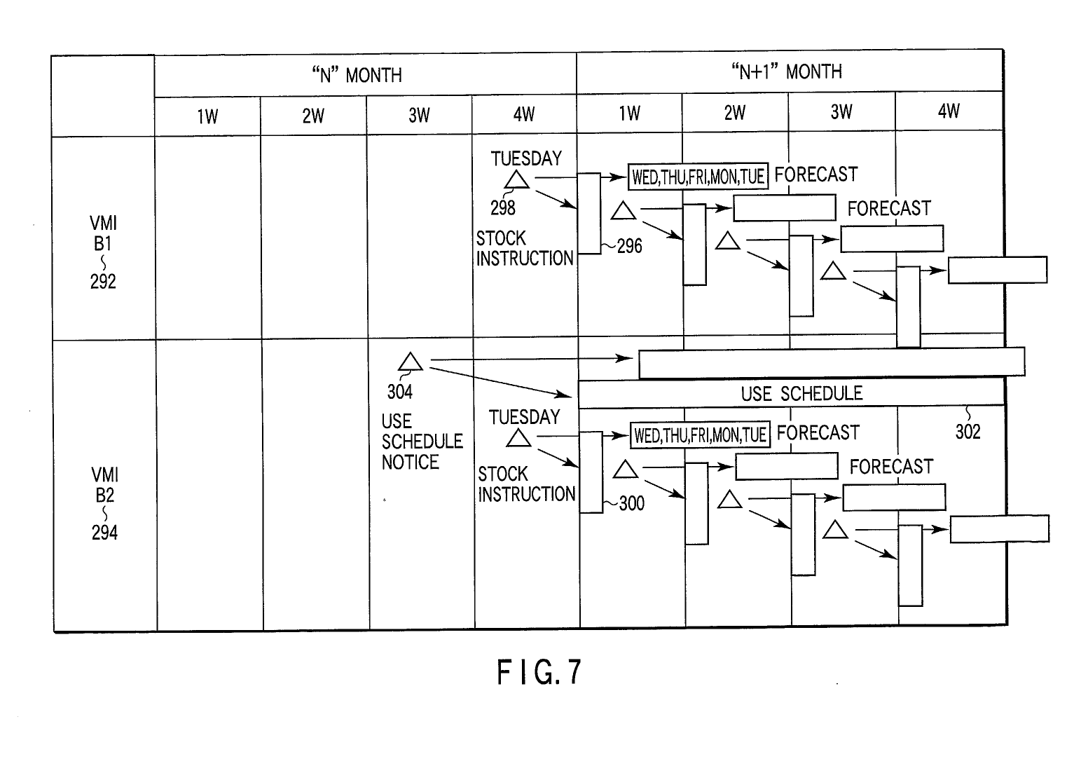

FIG. 7 shows an example of a forecast in both the VMI-B-1 and VMI-B-2 subsystems. With the forecast, an instruction for replenishing the stock is given to the vender in advance, and a weekly use schedule (for 12 weeks) of two or more weeks ahead is presented every week.

As shown in FIG. 7, for the VMI-B-1 not guaranteed to be taken subsystem 292, a VMI-B-1 stock instruction 296 based on a start plan (type and number of components desired to be delivered by the next Monday) is presented every Tuesday 298. For the VMI-B-2 guaranteed to be taken subsystem 294, in addition to a VMI-B-2 stock instruction 300, a use schedule notice 302 (the type, number, and schedule of components to be used in four weeks ahead of Monday after the next Monday) is presented every Tuesday 304. The VMI-B-2 stock instruction 300 is not based on the start plan, but instead is based on a component demand forecast PSI 176 (as shown in FIG. 3A). Here, the component demand forecast PSI 176 is a demand forecast generated from a monthly sales prospect 172 reported from the sales division 156 (as shown in FIG. 3A). Blanket purchasing order (BPO) is a use schedule notice which guarantees the taking of a quantity described in the notice. A release purchasing order (RPO) is a deposit stock plan, usually updating a quantity of stock replenishment necessary by the next Monday, and is also called warehousing schedule data.

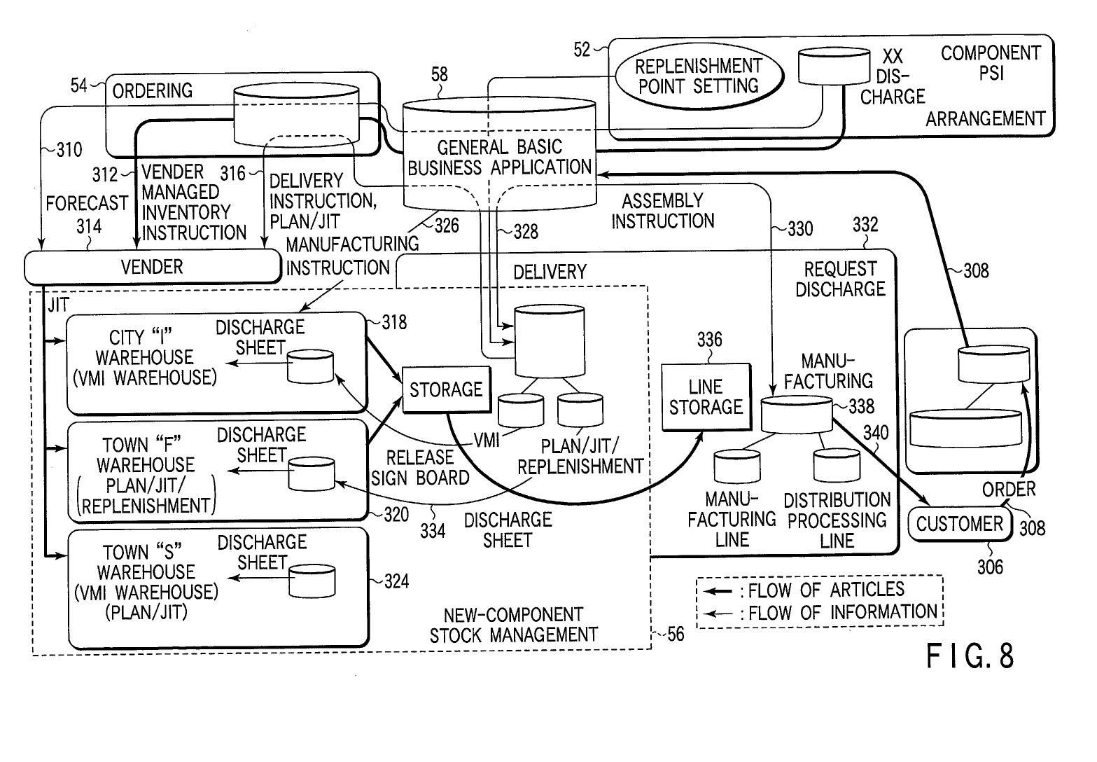

FIG. 8 is a schematic diagram showing a data flow of the assembly-to-order production system 110 including the component procurement system. The present system comprises a material procurement support system 52, a material management system 54, and a new-component stock management system 56. These systems are controlled by a general basic business application 58. The material management system 54 issues the forecast 310 and vender managed inventory instruction 312 to the vender 314 for the vender managed inventory (VMI) components or the intermediate products, and further gives a planned JIT/planned procurement delivery instruction 316 to the vender for the components of the planned JIT system and planned procurement system. Each component or each intermediate product is delivered into the respective warehouses 318, 320, and 324 (managed by the new-component stock management system 56) in accordance with the procurement system. The components in these warehouses are subjected to component processing in the warehouses based on a manufacturing instruction 326 from the general basic business application 58, and stocked as the intermediate products.

When a customer 306 gives an order 308 to the general basic business application 58, the application 58 gives a delivery instruction 328 to the new-component stock management system 56, and gives an assembly instruction 330 to the manufacturing division 332. In response to the delivery instruction 328, a release sign board or a discharge sheet 334 is given to the warehouses, and the intermediate products are discharged from the warehouses, stored in a line storage 336 of the manufacturing division 332, subjected to the final assembly 338, and shipped 340.

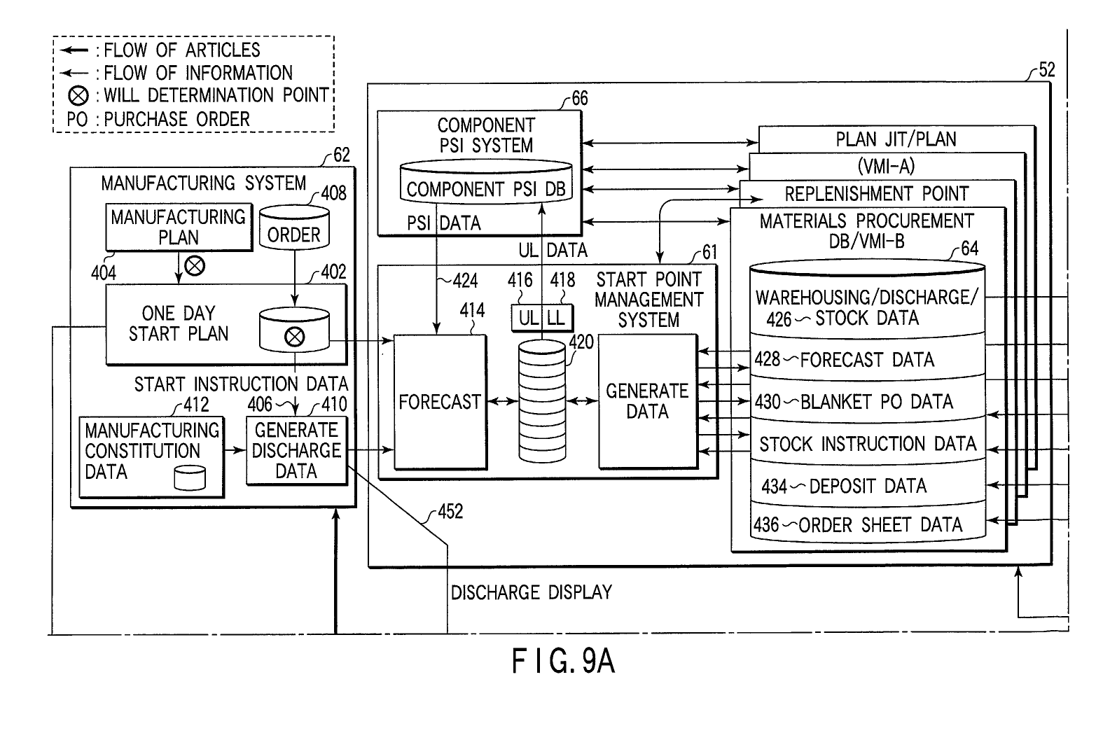

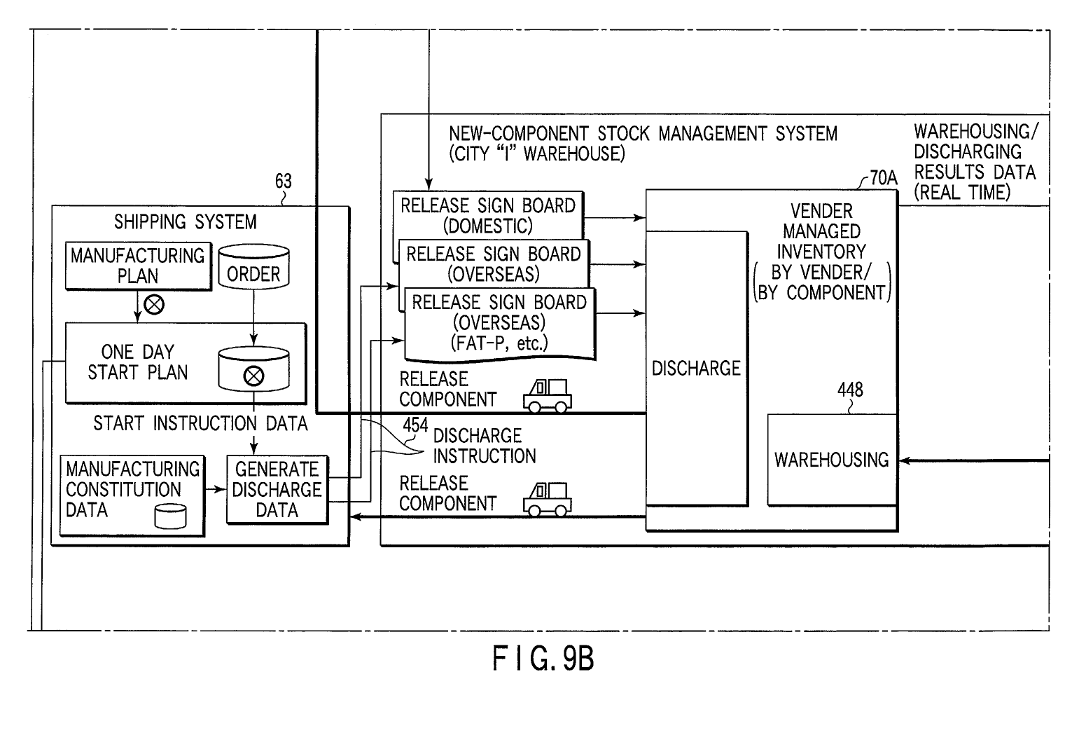

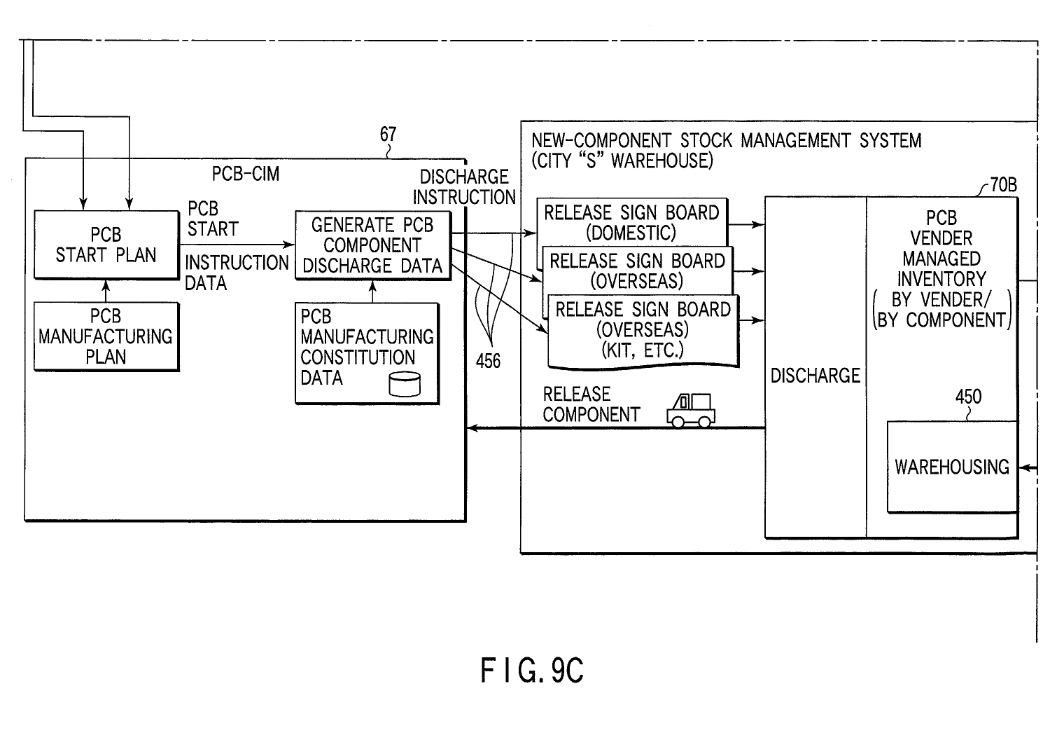

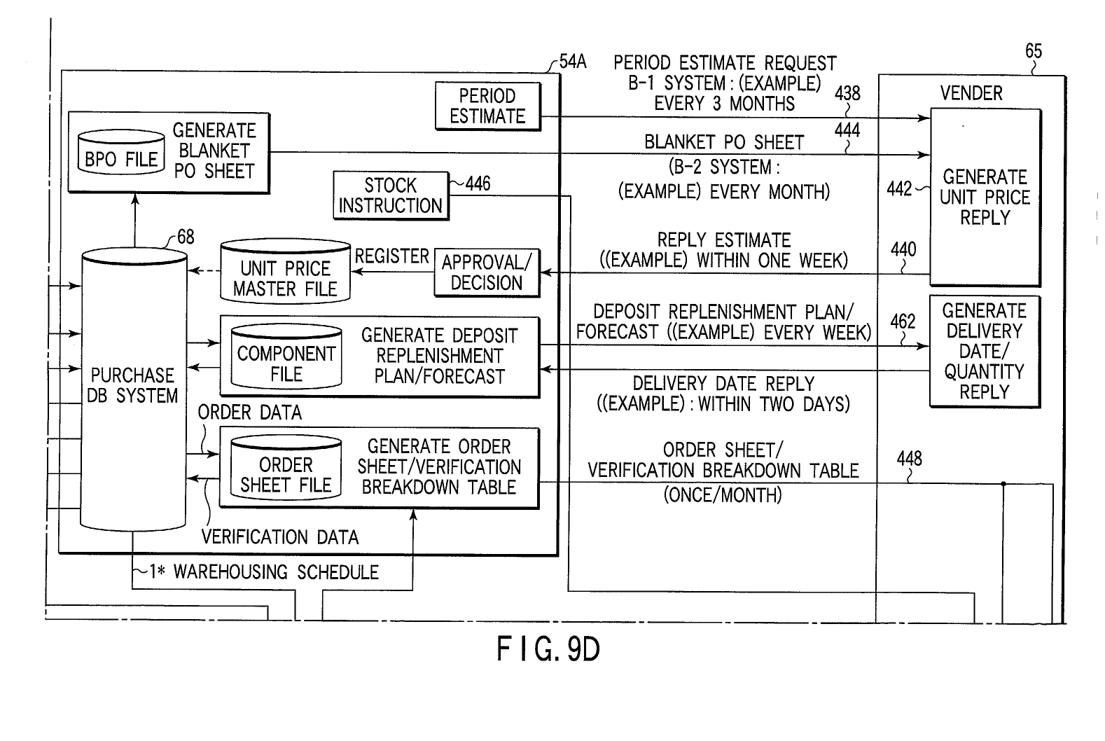

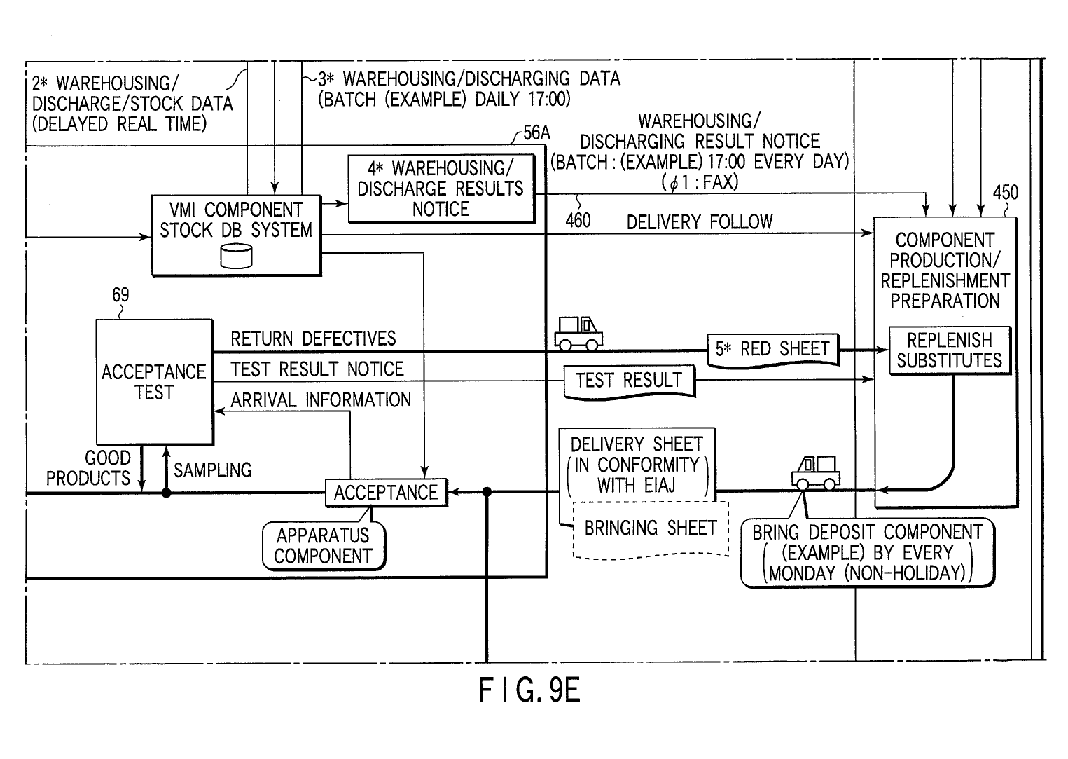

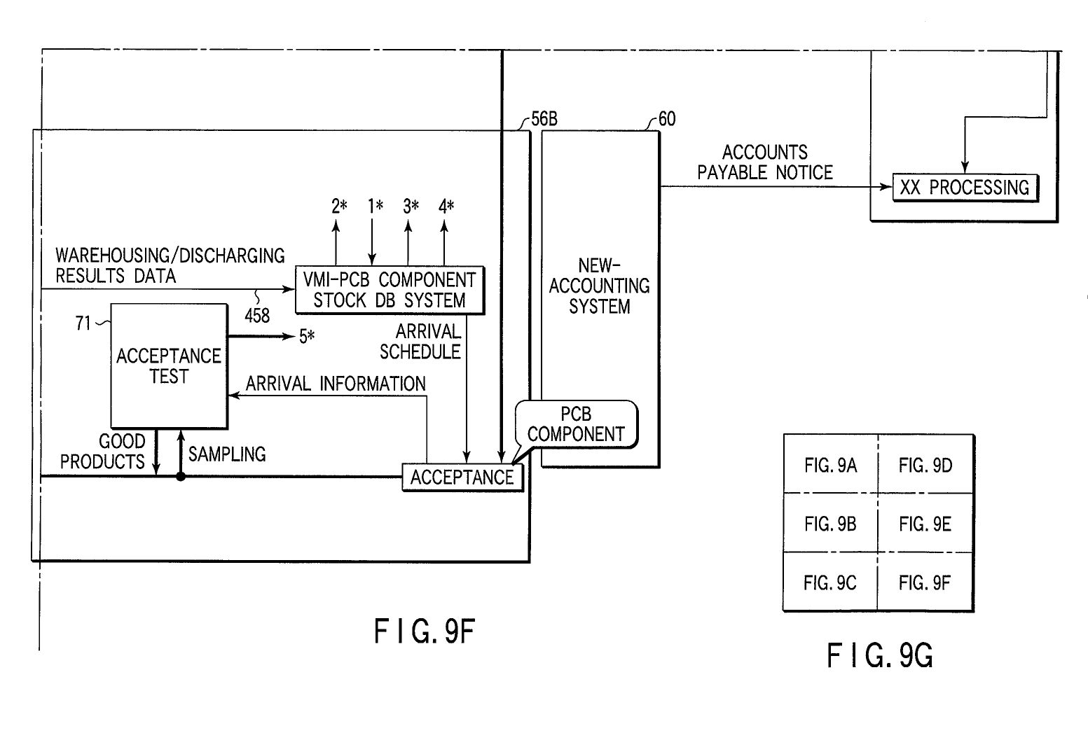

FIGS. 9A, 9B, 9C, 9D, 9E, and 9F, arranged according to FIG. 9G, show a detailed system configuration of FIG. 8. The material management system 54 is modified as a VMI material management system 54A, and the new-component stock management system 56 is divided into new-component stock management systems 56A and 56B for the respective warehouses.

The material procurement support system 52 has the following functions.

(1) The system presents the forecast as a basis of the blanket purchasing order (BPO) and demand data as a basis of the release purchasing order (RPO) to the VMI material management system 54A.

(2) The system presents the demand data as the basis of the release purchasing order (RPO) via a terminal demand.

(3) The system has a mechanism by which the component procurement division (VMI-B-1 and VMI-B-2) can be set.

The VMI material management system 54A has the following functions.

(1) The system prepares slips transferred between the orderer and the component vender in order to procure the VMI-B component.

(2) The system has a mechanism for transferring the slips to the vender. Examples of a transfer medium include paper, facsimile transmission, and the like.

(3) The system performs purchasing management of the VMI-B component, such as action management, periodic estimate processing, arbitrary estimate processing, BPO quantity application estimate processing, purchasing information retrieval, delivery date management, additional arrangement, delivery table reissue, and acceptance processing.

(4) The system registers a procurement division (VMI-B-1 and VMI-B-2), and ordering pattern of the VMI-B component into a material procurement master.

(5) The system cooperates with associated systems such as the material procurement support system 52, new-component stock management systems 56A and 56B, accounting system 60, and acceptance test information system (69, 71).

The new-component stock management systems 56A and 56B have the following functions:

(1) acceptance processing of the deposit components;

(2) warehousing processing of the deposit components;

(3) discharge processing of the deposit components;

(4) release processing of the deposit components;

(5) sideways assignment processing of the deposit components; and

(6) cooperation with the associated systems such as the material procurement support system 52.

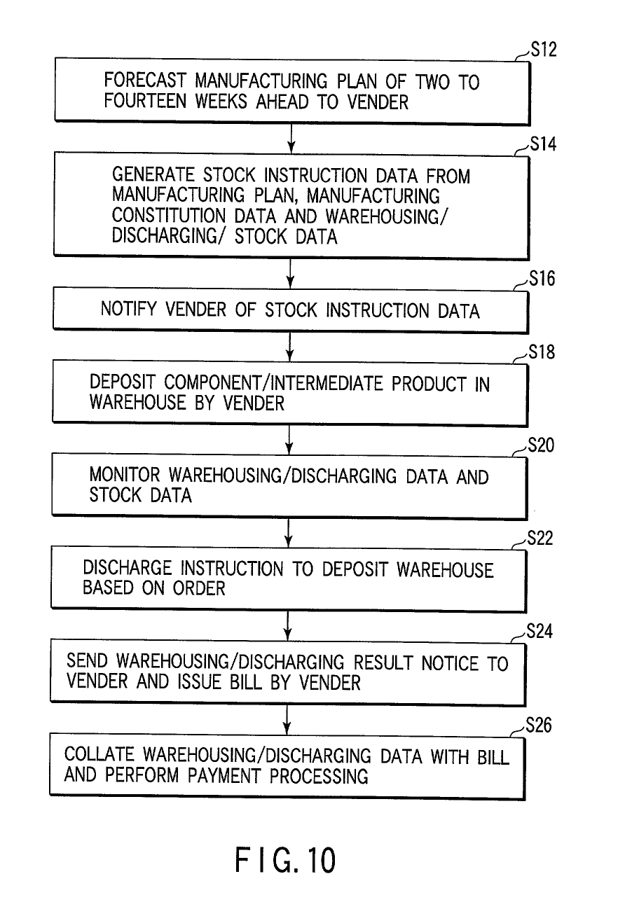

An embodiment of the system of FIGS. 9A, 9B, 9C, 9D, 9E, and 9F will now be described with reference to the flowchart of FIG. 10. In a manufacturing system 62, a one-day start plan 402 is established from a manufacturing plan 404 (manufacturing plan for one week looking two weeks ahead), and start instruction data 406 is obtained based on the one-day start plan 402 and order 408. Discharge data 410 is generated based on manufacturing constitution data 412 (type and number of components necessary for manufacturing a certain product) and start instruction data 406.

The start instruction data 406 and discharge data 410 are supplied to the material procurement support system 52, and a start point management system 61 forecasts 414 an upper limit 416 and lower limit 418 of a range 420 (the stock is kept in this range) of a replenishment point 422 of ordering based on demand forecast data 424 from a component PSI system 66. The material procurement support system 52 constructs a material procurement database (VMI-B database) 64 comprising warehousing/discharge/stock data 426, forecast data 428, use schedule notice data BPO 430, stock instruction data 432, deposit data 434, and order sheet data 436. The forecast data 428 is a manufacturing plan for one week looking two or more weeks ahead (e.g., 12 weeks ahead).

The data of the database 64 is supplied to a purchasing database system 68 of the VMI material management system 54A. The purchasing database system 68 sends the manufacturing plan 404 for one week looking two or more weeks ahead as the forecast data to the vender 65 (step S12). Examples of the vender 65 include not only the component vender but also an outside supplier who manufactures the intermediate products. The purchasing database system 68 sends a period estimate request 438 to the vender 65 with respect to the VMI-B-1 components every three months, and receives a reply estimate 440 from a unit price reply system 442. Moreover, for the VMI-B-2 components, the system sends the use schedule notice BPO 444 to the unit price reply system 442 of the vender 65 every month, and notifies the vender of the quantity of components guaranteed to be taken.

On the other hand, the purchasing database system 68 generates stock instruction data 446 from the manufacturing plan 404, manufacturing constitution data 412, and warehousing/discharge/stock data 426 supplied from the component stock management systems 56A and 56B (step S14). The warehousing data of the warehousing/discharge/stock data 426 indicate a quantity warehoused in a deposit warehouse (70A, 70B), the discharge data of the warehousing/discharge/stock data 426 indicate a quantity discharged from the deposit warehouse(70A, 70B), and the stock data of the warehousing/discharge/stock data 426 indicate a quantity actually stocked in the warehouse (70A, 70B). In step S16, the vender 65 is notified of the stock instruction data 446. In reality, the vender 65 is not notified by the orderer, but instead the vender 65 inquires of the orderer.

Since the vender 65 manufactures the components or the intermediate products based on the forecast data, the components or the intermediate products can immediately be deposited in the orderer's warehouse (70A, 70B) in response to the stock instruction 446 (step S18). Here, the intermediate products such as a printed board are delivered into a deposit warehouse 70A of the new-component stock management system 56A, and the components are delivered into a deposit warehouse 70B of the new-component stock management system 56B. When the VMI material management system 54A transfers an order sheet 448 to a component production/replenishment preparation system 450 of the component vender 65, the processing of the components is started in the deposit warehouse 70B, and the components are stocked as the intermediate products. The components and intermediate products are stored in a deposit warehouse for every vender or component.

The components and intermediate products are released from the warehouse based on discharge instruction data 452, 454, and 456 from the manufacturing system 62, shipment system 63, and printed board manufacturing system (PCB-CIM) 67, respectively, and finally assembled (step S22). Warehousing/discharging with respect to the warehouse is constantly monitored in real time (step S20).

When the intermediate products are discharged from the warehouse (70A, 70B), the ownership shifts to the manufacturer from the vender 65, and the vender 65 is paid for a discharged amount. Therefore, the component stock management systems 56A and 56B notify the vender 65 of warehousing/discharge results data (458, 460) based on the warehousing/discharge data. The vender 65 can issue a bill based on the data (step S24). The warehousing/discharge data is fed back to the purchasing database of the VMI material management system 54A, and collated with bill data, and payment processing is performed (step S26).

Since the respective data is presented to the vender 65 via Internet EDI (venders can be browsed), in the present system, each vender is authenticated, only the data regarding the corresponding vender can be browsed, and data regarding other venders cannot be seen during a browse request from the vender.

In summary, the material management system 54A obtains an applicable purchase unit price via a period estimate sheet 438, and registers the unit price in a unit price master file. The vender 65 prepares components to be purchased based on the forecast data issued every week (starts manufacturing the components), refers to a deposit replenishment plan sheet 462 simultaneously issued, and delivers the components to be purchased into the VMI warehouse for deposit. The deposit means that the delivered components are stored as contractor (vender) property without shifting the ownership of the components. In the VMI warehouse, an acceptance test is implemented for the deposited components particularly requiring such a test. Products unpacked as required become an object guaranteed to be taken.

When the deposited components to be purchased are discharged from the warehouse for the final assembly by the manufacturing system, a sales contract is considered to be established (the ownership shifts to the manufacturer from the vender), and verification processing and accounts payable processing are performed. Information of warehousing/discharge results of the deposit component (delivery result, acceptance test result, discharge result, inventory balance) can be browsed at any time. In response to a contractor's request, a practical inventory in the presence of the contractor is implemented once a month, and at any time. For the order sheet and verification breakdown table, present-month results until month end are arranged and issued as an official document in the beginning of the next month.

As described above, according to the assembly-to-order production system 110 of this embodiment, the forecast data indicating the time and quantity by which the vender managed inventory is to be provided by the component vender is prepared based on the production plan, and presented to a component vender a predetermined period before the stock instruction. Additionally, the forecast data is modified in consideration of a fluctuation factor to prepare the stock instruction. The stock instruction is presented to the component vender a predetermined period before the discharge instruction, so that the components are stocked in the vender managed inventory. Moreover, the discharge instruction is given to the component vender, so that the vender managed inventory is discharged from the warehouse in response to the received order. Since the intermediate products are stocked in this manner, the fluctuation of demand can be handled without lengthening the lead time from the receipt of an order until the shipment of the product. Moreover, the vender managed inventory system (management of the stock as the vender's property) contributes, for the manufacturer, to the reduction of component inventory property, securing of a necessary amount of components, and stable procurement of components. Furthermore, by the forecast of the manufacturing plan in combination with the vender managed inventory system, the vender also benefits in that the component manufacturing production plan/delivery plan is stabilized.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein. For example, the product being manufactured by the present system is not limited to a personal computer, and the present invention can be applied to various types of products.

What is claimed is:

1. An order assembly production system comprising:
first preparation means for preparing forecast data indicating a quantity and a time by which a component vender is to provide vender managed inventories based on a production plan;
first presentation means for presenting said forecast data generated by said first preparation means to said component vender a predetermined period before a presentation of a stock instruction;
second preparation means for modifying said forecast data in consideration of a fluctuation factor, and preparing said stock instruction;
second presentation means for presenting said stock instruction generated by said second preparation means to said component vender a predetermined period before a presentation of a discharge instruction;
means for storing said vender managed inventories based on said stock instruction presented by said second presentation means; and
third presentation means for presenting said discharge instruction to said component vender to discharge said vender managed inventories stored by said storing means in accordance with an order.

2. The system according to claim 1, wherein said vender managed inventories are general-purpose intermediate products which can be used in common to a plurality of products.

3. An order assembly production method comprising:
preparing forecast data indicating a quantity and a time by which a component vender is to provide vender managed inventories based on a production plan;
presenting said forecast data to said component vender a predetermined period before a presentation of a stock instruction;
modifying said forecast data in consideration of a fluctuation factor, and preparing said stock instruction;
presenting said stock instruction to said component vender a predetermined period before a presentation of a discharge instruction;
storing said vender managed inventories based on said stock instruction; and
presenting said discharge instruction to said component vender to discharge said vender managed inventories in accordance with an order.

4. The method according to claim 3, wherein said vender managed inventories are general-purpose intermediate products which can be used in common to a plurality of products.

5. An order assembly production system comprising:
means for calculating demand forecast data based on sales prospect data;
means for calculating material required amount plan data based on a received order and said demand forecast data;
means for issuing an order to a component vender based on said material required amount plan data, and warehousing components in a component warehouse;
manufacturing instruction means for processing said components in said component warehouse based on said material required amount plan data, and manufacturing intermediate products;
means for storing said intermediate products manufactured by said manufacturing instruction means; and
means for processing said intermediate products in said storing means based on said received order, and starting manufacturing of a final product.

6. The system according to claim 5, further comprising means for monitoring a stock amount of said component warehouse, and issuing an order to said component vender to obtain a defined stock amount when said stock amount is less than a predetermined amount.

7. The system according to claim 5, wherein said storing means stores said intermediate products as a vender managed inventory without shifting ownership, and said component vender is paid for an amount of the intermediate products discharged from said storing means.

8. An order assembly production method comprising steps of:
depositing at least one of intermediate products processed from a component of a component vender and intermediate products of the component vender in a warehouse of a manufacturer while ownership remains in said component vender;
discharging said deposited intermediate products from said warehouse in response to a received order;
performing final assembly by said manufacturer using said discharged intermediate products; and
paying said component vender for said discharged intermediate products.

9. The method according to claim 8, wherein said intermediate products are market general-purpose products which can be used in common to products of another company.

10. The method according to claim 8, further comprising a step of notifying said component vender of stock replenishment data indicating a quantity and a time for replenishing said deposited intermediate products beforehand.

11. An order assembly production method comprising steps of:
forecasting a manufacturing plan for at least one of a component delivery company and intermediate product delivery company;
indicating a delivery quantity of at least one of components and intermediate products to at least one of said component delivery company and intermediate product delivery company based on said manufacturing plan, a component constitution of a product, and a stock situation;
depositing at least one of said indicated components and intermediate products in a warehouse;
releasing at least one of said deposited components and intermediate products out of said warehouse in response to a received order; and
assembling final products using at least one of said released components and intermediate products.

12. The method according to claim 11, further comprising steps of:
monitoring a warehoused quantity and a quantity discharged from said warehouse;
detecting said quantity of at least one of said components and intermediate products used for assembling said final products based on said monitored quantities; and
paying at least one of said component delivery company and intermediate product delivery company based on said detected quantity.

13. An order assembly production method comprising steps of:
providing forecast data from a manufacturer to a vender at a first time period before provision of a stock instruction from said manufacturer to said vender, said forecast data including a first prospect amount of at least one of a component and an intermediate product to be incorporated into a final product, said first prospect amount to be provided as vender managed inventories by said vendor;
providing from said manufacturer to said vender, at a second time period before manufacturing said final product and after said first time period, a stock instruction including a second prospect amount of said at least one component and intermediate product, said second prospect amount to be made presently accessible to said manufacturer by said vender; and
retrieving by said manufacturer from said accessible amount an amount required by said manufacturer to manufacture a number of ordered final products.

14. An order assembly production method comprising steps of:
instructing a vender to make accessible to a manufacturer a production plan-based number of components;
retrieving by said manufacturer from said production plan-based number of components a manufacturing schedule-based number of components;
processing said manufacturing schedule-based number of components to manufacture intermediate products in accordance with said manufacturing schedule; and
assembling said intermediate products to manufacture a final product in accordance with a received order.
